(19) United States
(12) Patent Application Publication
(10) Pub. No.: US 2010/0009047 A1
(43) Pub. Date: Jan. 14, 2010

(54) Enhanced Fresh Meat

(76) Inventors: Matthew Gardner, Sedgwick, KS (US); David McKenna, Sedgwick, KS (US)

Correspondence Address: CARGILL, INCORPORATED, P.O. Box 5624, MINNEAPOLIS, MN, 55440-5624, US

(21) Appl. No.: 12/086,382

(22) PCT Filed: Dec. 15, 2006
(86) PCT No.: PCT/US2006/047989

§ 371 Date: Aug. 21, 2009

Related U.S. Application Data
(60) Provisional application No. 60/750,477, filed on Dec. 15, 2005.

(51) Int. Cl. A23L 1/31; A23B 4/20

(52) U.S. Cl. 426/281; 426/332

(57) ABSTRACT

This invention includes brine mixtures and methods for enhancing fresh meat cuts with brine mixtures. In selected embodiments, the brine mixture includes gelatin, water and optional additives. In one embodiment the brine mixture may be substantially or entirely free of phosphates.

### TECHNICAL FIELD

The present invention relates to compositions and methods for enhancing fresh meat products. The present invention further relates to gelatin compositions for enhancing fresh meat products.

### BACKGROUND

Fresh (i.e., raw) meat cuts lose water during the time the cuts are initially processed in a slaughterhouse, aged, transported, and displayed for retail purchase (collectively referred to herein as “storage”). Additional water loss occurs when the fresh meat cuts are cooked for consumption.

Because water loss during storage and/or cooking may negatively impact the visual appeal and/or palatability of fresh meat, various approaches have been used to prevent water loss. One common approach for preventing water loss is to enhance fresh meat cuts with an aqueous mixture, commonly referred to as brine, during initial meat processing. As used herein, enhanced meat cuts refer to fresh meat cuts that have been treated with a brine. In addition to water, the most common ingredients used in conventional brines include salts (e.g., sodium and/or potassium chloride), phosphates (e.g., sodium phosphate), antioxidants and flavorings.

Conventional brines increase the water content of meat cuts in at least two ways. First, certain components in the brine (e.g., salt and phosphate) may cause the swelling of the myofibrils, which results in better water retention of enhanced meat. The brining process typically increases the weight of fresh meat cuts between about five to fifteen percent. Although some of this water evaporates during cooking, the meat has a higher water content when cooking commences, and thus, the cooked meat may have a higher water content (compared to un-enhanced meat) after cooking.

Second, conventional brines may include components such as phosphates that influence the pH of the meat, to further improve water retention by increasing the hydrogen ion concentration (and thus the number of positively charged water binding sites) of the meat proteins. The combination of phosphate and salt may also cause meat myofibrils to swell by disassociating the bonds between actin and myosin. This swelling will allow more room for water within the myofibril. The application of phosphate to meat may therefore induce a different texture to the meat.

Depending on the amount and type of brine used, the brining process may reduce moisture loss during cooking to as little as fifteen percent.

One drawback to the use of conventional brines to enhance fresh meat cuts, particularly brines that influence the pH of the brine, is that the color of the enhanced fresh meat cut prior to cooking may be adversely affected. For example, conventionally enhanced fresh meat cuts may darken (e.g., may exhibit brown and/or green colors on the surface of the meat) between the time the fresh meat cut is brined and displayed for retail purchase. Such darkening may make the enhanced fresh meat cut appear less desirable to consumers in a retail display setting. Additionally, fresh meat cuts enhanced with conventional brines may possess an unnatural, processed texture after cooking, more commonly found in products like ham.

There is a need in the art for compositions and methods for enhancing fresh meat cuts that overcome one or more of these drawbacks.

### SUMMARY

In one embodiment, the present invention may provide brine mixtures for enhancing fresh meat cuts, and in particular fresh beef cuts. The brine mixture may include gelatin, water and optional additives, and may be substantially free of phosphates. For example, the brine mixture may contain between about 0.1 weight percent to about 10 weight percent gelatin and between about 50 weight percent and about 99 weight percent water. Optional additives for the brine mixtures include salts, lactates (either sodium or potassium) or other antimicrobial agents, natural and synthetic antioxidants, and flavorings. In another embodiment, the brine mixture generally contains less than about 2.0 weight percent phosphates. In particular embodiments, the brine may be entirely free of phosphates.

In another embodiment, the present invention may provide an enhanced fresh meat product including between about 0.05 and about 2.0 weight percent gelatin dispersed throughout a fresh meat cut. The enhanced fresh meat product may also be substantially or entirely free of phosphates, and may have a pH of between about 5-7.

In a further embodiment, the present invention may provide a method of enhancing a fresh meat cut by preparing a brine mixture, which contains gelatin and water and which is substantially or entirely free of phosphates. The brine mixture may be then dispersed into the fresh meat cut at a temperature between about 30° F. and 70° F. The fresh meat cut may be enhanced with a sufficient amount of the brine mixture to increase the weight of the fresh meat cut by between about 5 weight percent and about 20 weight percent.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive.

### BRIEF DESCRIPTION OF THE DRAWINGS

FIG. 1 illustrates a chart summarizing the L* value of fresh meat cuts for one example of the present invention.

FIG. 2 illustrates a chart summarizing the a* value of fresh meat cuts for one example of the present invention.

FIG. 3 illustrates a chart summarizing the L* value of beef steaks for another example of the present invention.

FIG. 4 illustrates a chart summarizing the L* value of pork chops for another example of the present invention.

FIG. 5 illustrates a chart summarizing the a* value of beef steaks for another example of the present invention.

FIG. 6 illustrates a chart summarizing the a* value of pork chops for another example of the present invention.

### DETAILED DESCRIPTION

The present invention may provide a gelatin enhanced brine mixture and a method for enhancing fresh meat cuts using the same. As used herein, the phrase “fresh meat cut(s)” refers to any type or cut of meat after slaughter and prior to cooking. For example, fresh meat cuts may include, but are not limited to, fresh, chilled, or frozen meat cuts. Suitable fresh meat cuts may be obtained from bovine, porcine, equine, caprine, ovine, avian animals, fish, or any animal commonly slaughtered for food production. Bovine animals may include, but are not limited to, buffalo, and all cattle, including steers, heifers, cows, and bulls. Porcine animals may include, but are not limited to, feeder pigs and breeding pigs, including sows, gilts, barrows, and boars. Ovine animals may include, but are not limited to, sheep, including ewes, rams, wethers, and lambs. Poultry may include, but are not limited to, chicken, turkey, and ostrich. Although the following description is directed towards fresh beef cuts, embodiments of the present invention may be suitable for other types of fresh meat.

In one embodiment, the brine mixture includes gelatin and water. Gelatin is a material derived from a mixture of proteins obtained by hydrolysis of collagen by boiling animal tissue such as bone, skin, ligaments, tendons, or hides. Gelatin may be classified as type A gelatin, which is obtained from acid-treated animal tissue, or type B gelatin, which is obtained from alkali-treated animal tissue. Gelatin may also be processed into a hydrolyzed form in which the gelatin protein chains are further broken down. Gelatin is strongly hydrophilic and may be capable of absorbing up to 10 times its weight in water.

Suitable gelatins for use in the brine mixtures of the present invention may include type A gelatins, type B gelatins, hydrolyzed gelatins, and combinations or derivatives thereof. Gelatin is widely available in either powder or flake form from a number of commercial sources. Examples of commercially available gelatins include Flavorlean 201-B™ and Flavex 95™ brand gelatins produced by Flavex Technologies, as well as gelatins available from Rousselot, PB, and Knox companies. Commercially available gelatins may also contain minimal amounts of beef stock, preservatives and other additives.

The amount or concentration of gelatin in the brine mixture may vary depending on the particular type of fresh meat to be enhanced, the specific meat cut, the type of gelatin used, the expected storage time of the enhanced fresh meat cut and/or the anticipated cooking method. In one embodiment the brine mixture may include between about 0.1 and 10.0 weight percent gelatin. In another embodiment, the brine mixture includes between about 0.75 weight percent and about 5.0 weight percent gelatin. In still another embodiment, the brine mixture includes between about 1.0 and about 3.0 weight percent gelatin. In another embodiment, the gelatin enhanced bring may include between about 0.1 and 0.9 weight percent gelatin. The brine may also include between about 50 weight percent and 99 weight percent water.

In one embodiment, the brine mixture may include gelatin but may be substantially free of phosphates such as sodium phosphate and/or other polyphosphates. In another embodiment, the brine mixture may contain less than about 3.0 weight percent, more particularly less than about 2.0 weight percent and more particularly less than about 1.0 weight percent phosphates. In a further embodiment, the brine mixture may be entirely free of phosphates.

The brine mixture of the present invention may also include a variety of optional additives. Examples of suitable additives may include salts, synthetic antioxidants, natural antioxidants such as rosemary, and bacterial and pathogen inhibitors such as sodium or potassium lactate. Additionally, flavorings such as beef stock or similar stock materials may be included to supplement water in the brine. In one embodiment, the brine mixture may include between about 50 to 96 weight percent water, between about 0.5 to 3.0 weight percent gelatin, between about 0.5 to 1.0 weight percent antioxidants, between about 0.2 to 0.5 weight percent beef stock, and between about 1.0 to 2.0 weight percent salt.

The brine mixture of embodiments of the present invention may have a pH close to the approximate pH of un-enhanced fresh meat. The resulting fresh meat cuts enhanced with these brine mixtures may therefore have a pH, between about 5 and 7, that is similar to un-enhanced fresh meat cuts. Enhanced meat cuts having a pH in this range may exhibit improved color characteristics compared to fresh meat cuts enhanced with brines that more substantially influence the pH of the fresh meat cuts.

The brine mixtures may be prepared by adding the gelatin and other optional ingredients to a predetermined amount of water. The temperature of the water to which the gelatin is added may affect the dissolution and/or binding capabilities of the gelatin. Depending on the amount and type of gelatin added to the water, the temperature of the water at the time the gelatin is added may range anywhere between the freezing point and boiling point of water. In certain embodiments, the water may be heated to its boiling point and the gelatin subsequently added. In other embodiments, and in particular embodiments utilizing hydrolyzed gelatins, the water need not be heated to its boiling point, or may not need to be heated at all prior to adding the gelatin.

The fresh meat cuts are enhanced with the brine mixtures of the present invention by dispersing the brine mixtures throughout the fresh meat cuts. Suitable methods for enhancing the fresh meat cuts with brines may include injecting, pumping, spraying, soaking, dipping or otherwise dispersing the brine mixture into or throughout the fresh meat cuts. In addition to the foregoing, the fresh meat cuts may be tumbled, kneaded, massaged or otherwise manipulated to further disperse the brine mixtures throughout the fresh meat cuts.

In one embodiment, for example, the brine mixture may be injected under pressure into a fresh meat cut as part of an automated commercial meat production process. Suitable injectors may be set to pump a particular volume of the brine mixture into each fresh meat cut. An example of a commercially available brine injector/pump is the Schröder IMAX 630 available from Wolf-Tech, Kingston, N.Y.

The fresh meat cuts may be injected or otherwise enhanced with a sufficient amount of the brine mixture to cause a weight increase of between about 5% to 20%, and more particularly about 10%. The actual amount of brine dispersed within the fresh meat and/or the weight gain of the fresh meat cut may vary depending on the method of enhancing the fresh meat cut, the type of meat, the particular meat cut and/or the particular brine mixture used. In one embodiment, the concentration of the brine mixture and the amount of brine dispersed into the fresh meat cut is controlled such that the enhanced fresh meat cut includes between about 0.05 and about 2.0 weight percent gelatin immediately after enhancement. In another embodiment, the concentration of the gelatin in the enhanced fresh meat cut is between about 0.7 and about 1.0 weight percent immediately after the brine is pumped into the fresh meat cut.

Prior to and while dispersing the brine mixture into the fresh meat cuts, the brine mixture may be maintained at a sufficient temperature to prevent the gelatin in the brine mixture from setting (i.e., converting to a gel-like state). The temperature at which the gelatin sets depends on the type of gelatin used and the concentration of the gelatin in the brine mixture. In one embodiment, the temperature of the brine mixture may be maintained at a range between about 25° F. to about 70° F. during injection. In other embodiments, the temperature of the brine is maintained between about 27° F. to about 42° F. during injection.

After enhancing the fresh meat cut with the brine mixture, the temperature of the enhanced fresh meat cut may be reduced to a temperature sufficient to cause the gelatin in the meat to set. For example, the temperature of the enhanced fresh meat cut may be reduced to between about 32° F. to about 36° F. Other embodiments may have higher or lower temperatures depending on the brine composition used. In one embodiment, the enhanced fresh meat cut may be vacuum-seated in a bag or similar container, which is then placed in cold water to reduce the temperature of the enhanced fresh meat cut.

As indicated in the examples set forth below, the brine mixtures of the present invention may be particularly useful for limiting the water loss of fresh meat cuts prior to cooking and during retail display. Consequently, such meat cuts may possess a higher total water content when cooking commences, which may result in a higher water content remaining after cooking meat, even if normal water loss occurs during cooking. The coloration of such fresh meat cuts may also be retained for a longer period of time up to and during retail display, such that the meat cuts have a more desirable appearance for a longer retail display time.

### Example I

Three USDA Select grade boneless strip loins were aged for eight days and cut into one-inch steaks. Steaks were alternately assigned to three groups, Sample Group A, Sample Group B, and a Control Group. Seven additional USDA Select grade boneless strip loins were divided into several large steaks, which were aged for two days from fabrication and labeled as Sample Group C.

Meat samples from Sample Groups A, B, and C were injected with corresponding brine mixtures A, B, and C identified in Table 1. The Control Group was not injected with a brine. Brine mixtures A, B, and C were prepared by combining each of the brine ingredients under agitation to form a generally uniform mixture.

TABLE 1

| | Brine Mixtures (weight percent) | | |
|---|---|---|---|
| Ingredients | A | B | C |
| Water | 95.86 | 95.50 | 96.425 |
| Salt | 1.65 | 1.65 | 1.815 |
| Beef Stock | | 0.44 | 0.44 |
| Rosemary | 0.55 | 0.55 | 0.55 |
| Flavorlean 201-B | 1.94 | | |
| Flavex 95 | | 1.86 | |
| Knox Gelatin | | | 0.77 |

As used in Table 1, the salt was a high-grade form of a 99.9 percent sodium chloride solution. The beef stock was an anhydrous form. The rosemary was an aqueous solution. Flavorlean 201-B is a combination of gelatin hydrosylate and beef stock available from Flavex. Flavex 95 is a gelatin hydrosylate material also available from Flavex. Knox brand gelatin is available from Kraft Foods.

Before and after injection, each meat cut was weighed to determine weight gain due to the brine injection. Meat cuts from Sample Groups A, B, and C were injected with the corresponding brine mixtures A, B, and C using a N-40 injector from Schröder Maschinenbau KG. The injector was set to pump sufficient brine into the meat cuts to raise the weight of the meat cuts by approximately 10 percent. Meat cuts from Sample Groups A and B were injected with the corresponding brines A and B at approximately 38° F. Meat cuts in Sample Group C were injected with brine C at 42° F. Variation in injection levels occurred because each meat cut accepted brine differently.

Following brine injection, the meat cuts from Sample Groups A and B were placed in retail meat trays, which were then over-wrapped in an oxygen permeable film. The trays were placed in a retail case at a temperature of 36° F. for five days. Each fresh meat sample was then cooked to an internal temperature of 145° F.

Meat cuts from Sample Group C were placed in a vacuum package after injection, and the package was placed in an ice water bath for approximately 10 minutes to aid gel formation in the meat. The meat cuts were then held for 7 days in a 34° F. cooler. At the end of this time, two one-inch cuts were removed from the larger steaks and placed in a retail tray over-wrapped with an oxygen permeable film and monitored under the conditions described for Samples A and B. Meat characteristics were then evaluated for each Sample Group.

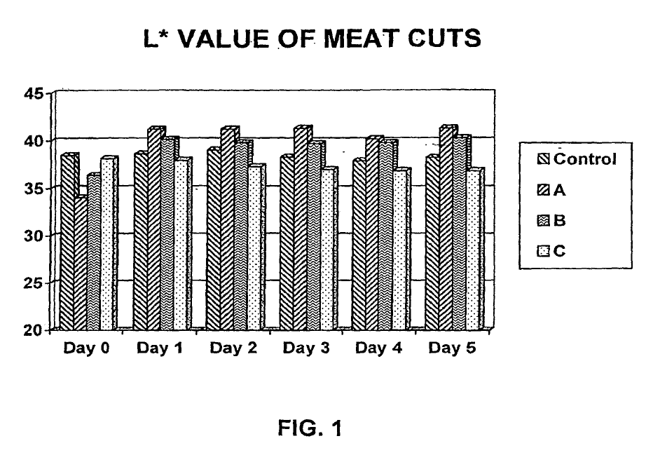

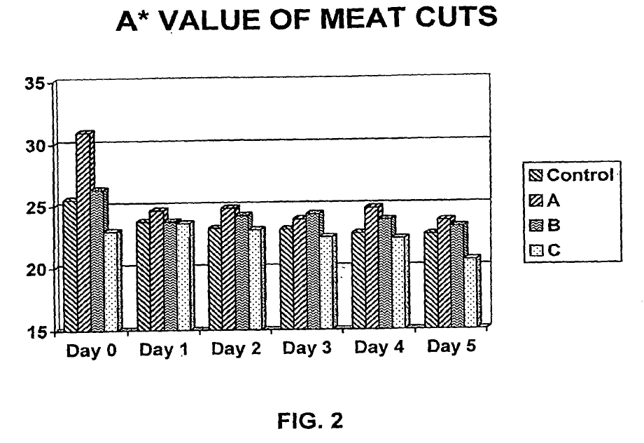

The average brightness (“L* value”) and the redness (“a* value”) of meat cuts in each Sample Group were measured using a HunterLab Miniscan spectophotometer available from Hunter Associates Laboratory, Inc. Reston, Va. The scale for the L* values ranges from zero (pure black) to 100 (pure white). Thus, as the L* values increase, the color of the meat sample appears lighter. In the case of the a* values, the more positive the a* values, the redder the sample and the more negative the a* value, the greener the sample. The results of the brightness and redness tests are set forth in FIGS. 1 and 2, respectively.

The results indicate that Sample Groups A and B retained similar, and in some cases better, brightness characteristics and similar color characteristics over the five-day period compared to the Control Group. Percent retail drip loss for Sample Groups A and B was measured by comparing the weight of each fresh meat cut from these Sample Groups immediately after brining to the weight of the same fresh meat sample after being stored for five days in the retail display case. Percent cook loss was measured by comparing the weight of each fresh meat sample after being stored for five days in the retail display case with the weight of the same sample after cooking. Percent total loss was measured by comparing the green start weight (pre-brining) weight of each fresh meat cut with the weight of the same meat cut after cooking.

TABLE 2

| | Sample Groups | | |
|---|---|---|---|
| | Control | A | B |
| Retail drip loss % | 1.84 | 3.86 | 3.83 |
| Cook Loss % | 17.62 | 19.19 | 20.29 |
| Total Loss % | 19.15 | 13.14 | 12.46 |

The results set forth in Table 2 indicate that Sample Groups A and B exhibited less total loss than the Control Group. Taken together, the results of Table 2 indicate that Sample Groups A and B had higher water content after cooking than the Control Group.

For Sample Group C, purge loss was calculated by comparing the weight of the steaks immediately after injection to the weight of the steaks after seven days of storage in the vacuum package. Retail drip loss was measured by comparing the weight of the meat cuts removed from the steak after removal from the vacuum package to the weight of the cuts after five days in retail display. Results are set forth in Table 3 below.

TABLE 3

| | Sample Group C |
|---|---|
| 7 day purge loss % | 2.07 |
| Retail drip loss % | 1.79 |
| Cook Loss % | 22.84 |

Table 4 below shows the average pH of the meat cuts in Samples Groups A and B as well as the Control Group.

TABLE 4

| | Sample Groups | | |
|---|---|---|---|
| | Control | A | B |
| pH | 5.50 | 5.55 | 5.53 |

The results set forth in Table 5 indicate that Sample A and B had similar pH levels to the Control Group.

### Example II

In a second example, the water-binding properties, color, and eating characteristics of fresh meat product enhanced with a gelatin based brine solution was analyzed. -The goal of this test was to determine whether flavor, color and texture of a fresh meat product can be improved by application of a gelatin based brine solution without affecting the tenderness, juiciness and shelf-life of the product.

Twelve USDA Select boneless beef strip loins, aged seventeen days from fabrication, were cut into one-third sections. Similarly, twelve boneless pork loins, aged seven days from fabrication, were also cut into one-third sections. Each of the beef and pork sections were assigned to the following enhancement protocols:

1. Non-enhanced (CON)
2. Phosphate enhanced (PE)
3. Gelatin enhanced (GE)

Table 5 lists the brine ingredients for the phosphate and gelatin enhanced treatments. The gelatin was 225 Bloom, Type B, from Rousselot, the beef stock was from Proliant Ingredients, #1301, and the sodium phosphate was in anhydrous form. Each brine treatment was made by dissolving the ingredients in hot water.

TABLE 5

Brine Treatments

| | PE | GE |
|---|---|---|
| Water | 92.168% | 96.590% |
| Salt | 3.300% | 1.650% |
| Sodium phosphate | 3.850% | |
| Beef Stock | 0.682% | 0.715% |
| Gelatin | | 1.045% |

Each fresh meat section was injected with a target pump level of 10.0% using a Schröder IMAX 520 from Wolf-Tech, Kingston, N.Y. Injection samples were weighed before and after injection to determine the increase in weight for each sample.

Following injection, the non-enhanced samples and the phosphate enhanced samples were put in Cryovac® bags and vacuum packaged. The gelatin enhanced samples were put in Cryovac® bags and then placed in an ice water bath for approximately ten minutes before being vacuum packaged in order to aid gel formation in the meat. All samples were thereafter held for six days in a 34° F. cooler. At the end of this time, one-inch steaks and pork chops were cut from the beef and pork sections.

Two pieces of meat from each beef and pork group, enhanced with the phosphate or gelatin brines, were placed in a retail tray and overwrapped in an oxygen permeable film. The retail trays containing the steaks were placed in the retail case and were monitored for color over four days at a case display temperature of approximately 36° F.

Two additional steaks and two additional pork chops were used for slice shear force tenderness testing. In order to complete the tenderness testing, the steaks and pork chops were first cooked to an internal temperature of 160° F. A slice parallel to the muscle fibers was then removed from the end of each piece of meat and placed in a texture analyzer. (TA.XT Plus, Texture Technologies Corp.) The texture analyzer measured the force to cut the steak and pork chops perpendicular to the muscle fibers. Cook loss on each steak and pork chop was also calculated using the before and after cooking weights of each steak and pork chop.

Table 6 shows the average pump levels (weight gain) attained for each treatment group. The pump levels were more consistent for the beef samples as opposed to the pork samples, but are both within acceptable ranges. Table 7 illustrates the water holding capacity as measured for each treatment group. As shown, the treated fresh meat samples in general lost more water during the purge, drip loss, and cook loss testing. However, because of the higher water content the final cooked product retained more water overall. Table 8 illustrates the slice shear force testing. The shear force to cut the beef samples was slightly higher for the gelatin enhanced brine in comparison to the non-enhanced and phosphate enhanced brine samples. The shear force to cut the pork chops was greatest for the control, least for the phosphate enhanced samples, and in the middle for the gelatin enhanced sample.

TABLE 6

| Brine Treatments | |
|---|---|
| Beef | Pork |

| | PE | GE | PE | GE |
|---|---|---|---|---|
| Pump level % | 10.04 | 9.99 | 11.90 | 9.45 |

TABLE 7

| | Brine Treatments | | | | | |
|---|---|---|---|---|---|---|
| | Beef | | | Pork | | |
| | CON | PE | GE | CON | PE | GE |
| 6 day purge | 2.53 | 3.86 | 5.59 | 3.07 | 1.76 | 4.00 |
| loss % | | | | | | |
| Retail drip | 2.42 | 2.80 | 3.09 | 2.61 | 2.93 | 4.07 |
| loss % | | | | | | |
| Cook Loss | 13.88 | 12.25 | 14.68 | 14.33 | 13.91 | 15.69 |
| % | | | | | | |

TABLE 8

| | Brine Treatments | | | | | |
|---|---|---|---|---|---|---|
| | Beef | | | Pork | | |
| | CON | PE | GE | CON | PE | GE |
| Slice Shear | 13.97 | 12.04 | 14.39 | 11.92 | 8.40 | 10.46 |
| Force (kg) | | | | | | |

One beef steak each from the control group and the gelatin treated group was cooked to an internal temperature of 160° F. and cut into one-inch cubes for sensory testing. Panelists evaluated a sample from each treatment group on tenderness, juiciness, flavor and overall acceptability. The taste panel included approximately 29 randomly selected workers at the testing facility who had no formalized training. Table 9 illustrates the sensory characteristics for the treatment groups. The pork was not analyzed in this manner.

TABLE 9

Brine Treatments

| | CON | GE |
|---|---|---|
| Tenderness^{a} | 6.09 | 6.37 |
| Juiciness^{b} | 5.74 | 6.48 |
| Beef Flavor^{c} | 5.16 | 5.71 |
| Overall acceptability^{d} | 5.59 | 6.51 |

^{a}Evaluated on a 10 point scale (0 = tough, 10 = tender)
^{b}Evaluated on a 10 point scale (0 = dry, 10 = juicy)
^{c}Evaluated on a 10 point scale (0 = dislike extremely, 10 = like extremely)
^{d}Evaluated on a 10 point scale (0 = dislike extremely, 10 = like extremely)

As is illustrated in Table 9, the gelatin brine enhanced beef had increased sensory characteristics for all of the testing categories as compared to the non-enhanced beef.

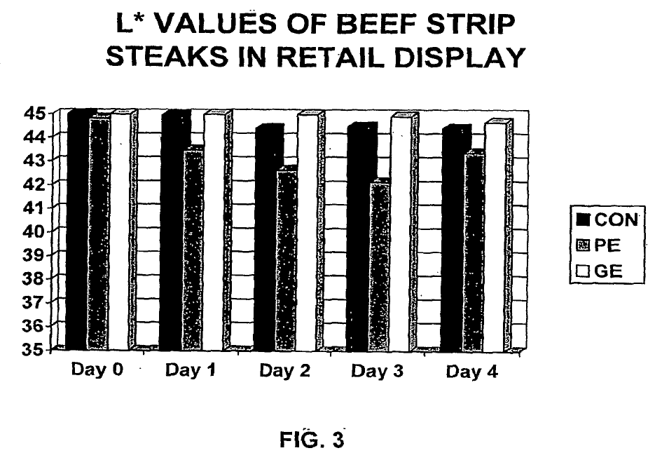

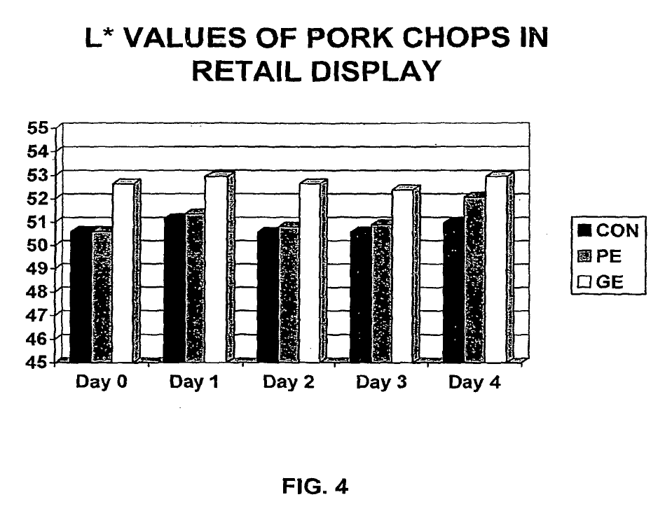

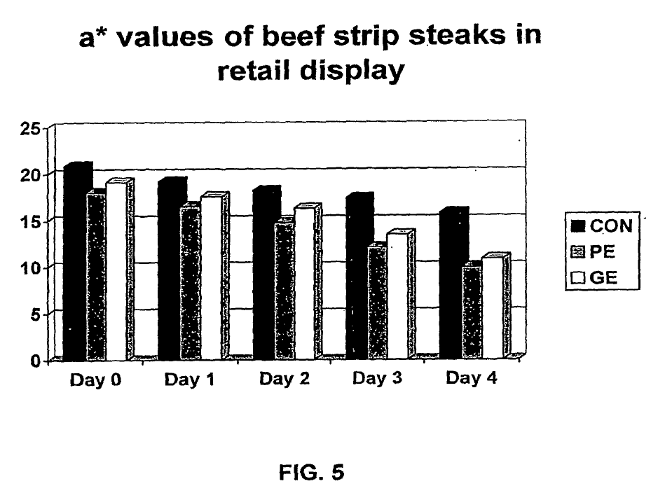

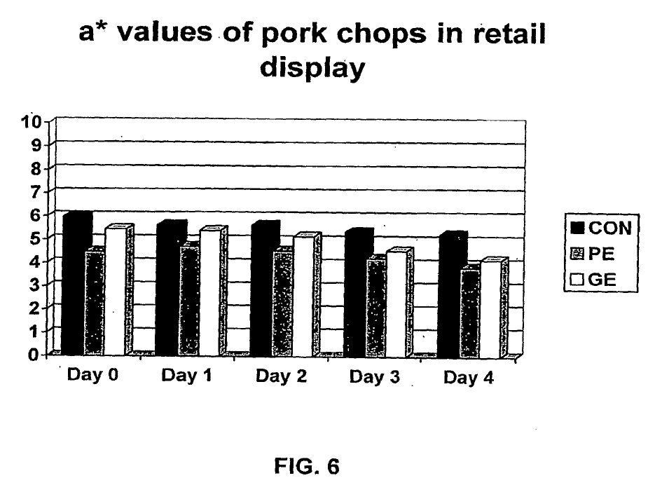

In addition, the average brightness and the redness of both the beef and pork meat cuts in each sample group were measured using a Minolta spectrophotometer. FIGS. 3 and 4 illustrate that the beef and pork treated with the gelatin enhanced brine retained a lighter color as compared to the phosphate enhanced meat and retained similar, and in some cases better, brightness characteristics than the non-enhanced meat. Moreover, as shown in FIGS. 5 and 6, both the beef and pork treated with gelatin enhanced brine retained a greater a* value throughout the testing period as compared to the phosphate enhanced meat. The a* values for the gelatin enhanced meat cuts were closer to the non-enhanced meat for both the beef and the pork and mean that the meat was more red in color.

It was therefore found that adding gelatin to the brine solution before injection into a fresh meat product increased the amount of water retained in the meat after vacuum packaging and packaging in a retail display tray as compared to non-enhanced meat. In addition, the cooked fresh meat beef had improved sensory characteristics. Unlike phosphate, gelatin does not act on the proteins in meat to bind water but is a water binder itself This may result in improved meat texture compared to phosphate enhanced fresh meat. Finally, the gelatin enhanced fresh meat had improved color characteristics over phosphate enhanced meat such that the color and brightness more resembled non-enhanced fresh meat.

The above-detailed embodiments and examples are intended to be illustrative, not exhaustive, and those skilled in the art will recognize that various equivalent modifications are possible within the scope of the invention. For example, whereas steps are presented in a given order, alternative embodiments may perform steps in a different order. The various embodiments described herein can be combined to provide further embodiments. Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1-9. (canceled)

10. A method for enhancing a fresh meat cut comprising: combining between about 0.5 and about 10.0 weight percent gelatin, between about 50.0 and about 99.5 weight percent water and one or more additives to form a brine mixture that is substantially or entirely free of phosphates; and injecting the fresh meat cut with the brine mixture.

11. The method of claim 10 further comprising injecting the brine mixture into the fresh meat cut at a temperature between about 30° F. and about 70° F.

12. The method of claim 10 further comprising injecting the brine mixture into the fresh meat cut with the brine at a temperature of about 35° F. and about 42° F.

13. The method of claim 10 further comprising heating the water.

14.-15. (canceled)

16. The method of claim 10 wherein forming the brine mixture further comprises adding beef stock to the brine mixture.

17. The method of claim 10 wherein forming the brine mixture further comprises adding salt to the brine mixture.

18. The method of claim 10 further comprising storing the meat product with the injected brine mixture for a pre-determined period of time.

19. The method of claim 10 wherein injecting the brine mixture into the meat product further comprises injecting enough brine mixture to increase the weight of the meat product by about 10.0 percent.

20. The method of claim 10 further comprising cooling the fresh meat product after injecting the brine mixture.

21. The method of claim 10, wherein the fresh meat cut is a beef cut.

22. The method of claim 10, wherein the fresh meat cut is a pork cut.

23. The method of claim 10 wherein the brine mixture further comprises one or more additives.

24. The method of claim 23 wherein the additive is one or more of salts, synthetic antioxidants, natural antioxidants, bacterial inhibitors, pathogen inhibitors, and flavorings.

25. The method of claim 23 wherein the additive is rosemary.

26. The method of claim 23 wherein the additive is sodium or potassium lactate.

27. The method of claim 10 wherein the brine mixture comprises about 0.3 to 1.0 weight percent gelatin.

28. The method of claim 10 wherein the weight percent gelatin is about 0.7 weight percent.
